(19) United States
(12) Patent Application Publication
(10) Pub. No.: US 2026/0311671 A1
(43) Pub. Date: Oct. 8, 2026

(54) Acoustic Control System, Active Acoustic Control System, and Method

(71) Applicant: BAE SYSTEMS PLC, London (GB)

(72) Inventors: Jordan Cheer, Southampton Hampshire (GB); Hui Li, Southampton Hampshire (GB)

(73) Assignee: BAE SYSTEMS PLC, London (GB)

(21) Appl. No.: 19/476,336

(22) PCT Filed: Apr. 15, 2024
(86) PCT No.: PCT/GB2024/050978

§ 371 Date: Oct. 17, 2025

(30) Foreign Application Priority Data
Apr. 21, 2023 (EP) 23275065.3
Apr. 21, 2023 (GB) 2305873.8

(51) Int. Cl. G10K 11/16; G10K 11/172

(52) U.S. Cl. CPC G10K 11/161; G10K 11/172

(57) ABSTRACT

According to the present disclosure there is provided an acoustic control system for controlling acoustic noise in a duct arranged to receive fluid flow therein, comprising: a resonator arrangement for connection to the duct, the resonator arrangement comprising a plurality of resonators, wherein the resonator arrangement is configured based on a flow rate of the fluid flow in the duct.

### FIELD

The present invention relates to an acoustic control system, in particular an acoustic control system for controlling acoustic noise in a duct arranged to received fluid flow therein. The present invention further relates to an active acoustic control system, and a method of controlling acoustic noise.

### BACKGROUND

Acoustic control systems are used to control acoustic noise. One example of an acoustic control system comprises a resonator arrangement. The resonator arrangement traps broadband acoustic waves and spatially separates different frequency components, as the result of dispersion and wave velocity control by designed gradient subwavelength structures. In this way, the resonator arrangement enables precise spatial-spectral control of acoustic waves.

Acoustic noise may be present in a duct arranged to receive, and receiving, fluid flow. Examples include ducts found in ventilation systems, cooling systems, combustion systems, enclosures, and cloaking design. Where flow is present, performance of existing acoustic control systems may be affected. In particular, the maximum of the transmission loss (which it is desired to maximise for optimal acoustic control) is reduced and the resonant frequencies changed or shifted, such that known acoustic control systems provide sub-optimal control of acoustic noise.

It is an object of the present invention to provide an improved acoustic control system, active acoustic control system and/or method thereof. Alternatively, or additionally, it is an object of the present invention to address one or more of the problems discussed above, or discussed elsewhere, or to at least provide an alternative system and/or method.

### SUMMARY

According to a first aspect of the present invention, there is provided an acoustic control system for controlling acoustic noise in a duct arranged to receive fluid flow therein, comprising: a resonator arrangement for connection to the duct, the resonator arrangement comprising a plurality of resonators, wherein the resonator arrangement is configured based on a flow rate of the fluid flow in the duct.

In one example, a resonance frequency of each resonator is based on the flow rate.

In one example, a resonance frequency of each resonator is based on position of the resonator relative to the duct.

In one example, the resonators are arranged to provide a variation in resonance frequency of each resonator with position of the resonators relative to the duct.

In one example, the variation is an increase or decrease in resonance frequency of each resonator along the length of the duct.

In one example, the resonator arrangement comprises Helmholtz resonators and/or quarter wavelength resonators.

In one example, the Helmholtz resonators comprise a neck and a cavity, wherein the neck and cavity are arranged to match a resonance frequency of acoustic noise that it is desired to control.

In one example, the neck extends into the cavity.

In one example, the neck comprises perforations.

In one example, the Helmholtz resonator comprises a flexible end plate.

In one example, the Helmholtz resonator is connected to an electromagnetic shaker and/or vibrating backplate, to act on the Helmholtz resonator to cause changes in the volume of the cavity.

In one example, the duct forms part of a combustion system or a ventilation system.

In one example, the resonator arrangement is provided in a series arrangement or parallel arrangement.

In one example, the fluid flow in the duct is a liquid flow.

In one example, the resonator arrangement comprises one or more resonators concentric with the duct.

In one example, the resonator arrangement is configurable based on the flow rate of the fluid flow in the duct.

According to a second aspect of the present invention, there is provided an active acoustic control system comprising: the acoustic control system according to the first aspect of the present invention; and an active control assembly arranged to control the resonator arrangement based on the flow rate of the fluid flow in the duct.

The active acoustic control system according to the second aspect may comprise any or all features of the acoustic control system according to the first aspect, as desired or as appropriate.

According to a third aspect of the present invention, there is provided a method of controlling acoustic noise in a duct arranged to receive fluid flow therein, comprising: providing a resonator arrangement for connection to the duct, the resonator arrangement comprising a plurality of resonators; and configuring the resonator arrangement based on a flow rate of the fluid flow in the duct.

The method according to the third aspect may comprise any or all features of the acoustic control system according to the first aspect and/or any or all features of the active acoustic control system according to the second aspect, as desired or as appropriate.

### BRIEF DESCRIPTION OF THE FIGURES

Embodiments of the invention will now be described by way of example only with reference to the figures, in which:

FIG. 1 shows an acoustic control system;

FIG. 2 shows a plot of absorption of acoustic noise;

FIG. 3 shows a comparative plot of quality factors in a flow and no-flow case;

FIG. 4 shows comparative plots of variables in a flow and no-flow case;

FIG. 5 shows a side view of a resonator;

FIG. 6 shows a perspective view of the resonator of FIG. 5;

FIG. 7 shows a resonator connected to a control assembly;

Figures and 9 show views of a concentric resonator;

FIG. 10 shows a schematic of the acoustic control system;

FIG. 11 shows a schematic of an active acoustic control system; and

FIG. 12 shows general methodology principles.

### DETAILED DESCRIPTION

In summary, the disclosure provided herein relates to an acoustic control system comprising a resonator arrangement configured based on a flow rate of fluid flow in a duct. Importantly, the resonator arrangement (in particular the tuning frequency of resonators) may be configured, or designed, in consideration of the flow rate of fluid flow in the duct. This is highly advantageous in realising effective control of acoustic noise in a fluidic duct.

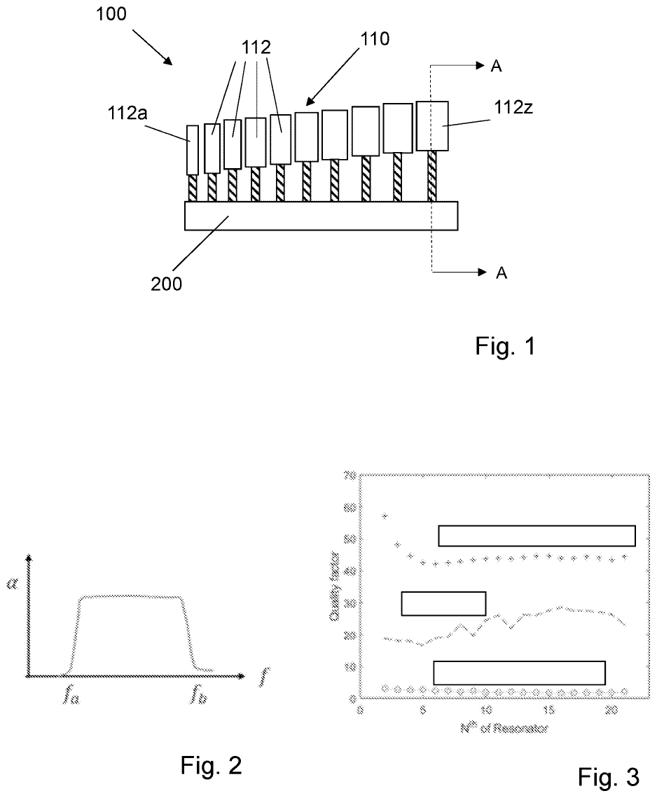

Referring to FIG. 1, an acoustic control system 100 is shown. The acoustic control system 100 is for controlling acoustic noise in a duct 200. The duct 200 is arranged to receive fluid flow therein.

The acoustic control system 100 comprises a resonator arrangement 110. The resonator arrangement 110 is for connection to the duct 200. The resonator arrangement 110 comprises a plurality of resonators 112. The resonator arrangement 110 is configured based on a flow rate of the fluid flow in the duct 200.

In other words, the resonator arrangement 110 is designed or constructed based on (i.e., in consideration of) the flow rate of the fluid flow in the duct 200. Prior art approaches do not consider the effect of fluid flow in a duct to which the resonator arrangement is connected to. When there is a fluid flow in the duct (which may be referred to as a “background flow”), the performance on the resonator arrangement may be negatively impacted, as the resonator arrangement is not configured based on a flow rate of the fluid flow in the duct.

An example of configuring the resonator arrangement 110 based on the flow rate of fluid flow in the duct 200 may include selecting, adjusting, or controlling the resonance (or “tuning”) frequency of the resonators 112 based on the flow rate of fluid flow in the duct 200. This may be by appropriate selection, adjustment or control of resonator shapes, sizes and/or types, based on the flow rate. A further example includes selecting, adjusting, or controlling the number of resonators 112 connected to the duct 200, based on the flow rate. Connection to the duct 200 may mean a connection made such that acoustic noise can be controlled by the resonators 112, which may include control of a control arrangement comprising valves and/or flaps, which allow acoustic noise to propagate from the duct 200 into the resonators 112. A flow rate sensor (not shown) may be provided in the duct 200, or elsewhere, and the output of the flow rate sensor used to configure the resonator arrangement 110.

As shown in FIG. 1, the resonators 112 are provided as “side branches” connected to the duct 200. The resonators 112 may be connected to the duct 200 at openings provided on, or through, the surface of the duct 200. The resonator arrangement 110 may be, or be provided as part of, a metamaterial.

It is an aim of the acoustic control system 100 to produce a smooth absorption of acoustic noise in a relatively wide frequency region in a duct 200 arranged to receive fluid flow (otherwise referred to as a “fluidic duct 200”). An example of smooth absorption is illustrated in FIG. 2. Loss (or absorption) coefficient a is shown to be constant in a frequency band fₐ-f_{b}, and falls rapidly outside of the frequency band. As described herein, this is achieved in the present invention by the resonator arrangement 110 being configured based on the flow rate of the fluid flow in the duct 200.

The quality factor of the resonators 112 of the resonator arrangement 110 are considered in configuring the resonator arrangement 110. The quality factor Q is defined as the ratio of input current to the reaction current of the system. With flow in the duct 200, it may be assumed that the ratio of the sound pressure in each resonator 112 to the incident sound is equal to the quality factor of the resonator 112 when there is flow in the duct 200. The ratio of quality factors of a resonator for the case with and without flow in the duct 200 is equal to the ratio of the sound pressure and the reaction sound pressure, where the reaction sound pressure is the sound pressure in the case of flow in the duct 200.

FIG. 3 shows a plot of the ratio of quality factor. In FIG. 3, the Q in the no-flow case is plotted in crosses, and flow case is plotted in circles. In this example, the flow rate is 132 m³/h. As can be established from FIG. 3, the Q value of the resonators reduce to around 1/16 to 1/25 of the value in the no-flow case. It is known in the art that the number of resonators required per octave is proportional to the square root of the Q value. Thus, the number of resonators required in the flow case reduces to ¼ to ⅕ of the number required in the no-flow case. In this way, considering flow in the duct 200, the number of resonators required can be reduced. The frequency range of control is 400 Hz to 1000 Hz. Each resonator controls a narrow range of frequencies. Acoustic noise of a particular frequency will be “trapped”, or absorbed, at a target resonator as well as at neighbouring resonators.

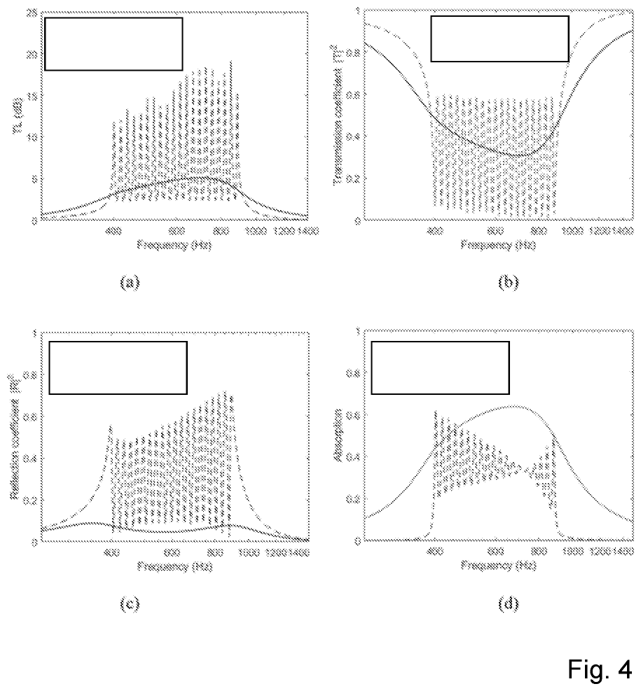

FIG. 4 shows plots of transmission loss (TL) (FIG. 4(a)), transmission coefficient (FIG. 4(b)), reflection coefficient (FIG. 4(c)) and absorption (FIG. 4(d)), each against frequency of acoustic noise in the duct 200. The no-flow case is shown in dashed line and the flow case is shown in solid line. The flow affects the performance of the resonator arrangement 110. As shown in FIG. 4, the transmission loss in the flow case reduces and does not have the peaks that are present in the no-flow case. The reflection coefficient in the flow case also decreases and is smoothly varying. As a result, the absorption of the resonator arrangement 110 in the flow case increases and is smoothly varying in the control range (which in this case is 400 Hz to 1 kHz).

Referring back to FIG. 1, the resonators 112 of the resonator arrangement 112 are configured to provide an exponential distribution of resonance frequency. The resonator arrangement 112 comprises a basal resonator 112a (i.e., the first resonator 112 in the resonator arrangement 110), and an apical resonator 112z (i.e., the final resonator 112 in the resonator arrangement 110). The resonance frequency (or tuning frequency) of the resonators 112 increases exponentially from the basal resonator 112a to the apical resonator 112z. In this way, a high and smooth transmission loss and absorption coefficient is realised in a wide frequency band.

The resonance frequency of each resonator 112 may be based on the flow rate. In an example, this may include selecting, adjusting, or controlling the resonance (or “tuning”) frequency of the resonators 112 based on the flow rate of fluid flow in the duct 200. This may be by appropriate selection, adjustment or control of resonator shapes, sizes and/or types, based on the flow rate. A further example includes selecting, adjusting, or controlling the number of resonators 112 connected to the duct 200, based on the flow rate. Connection to the duct 200 may mean a connection made such that acoustic noise can be controlled by the resonators 112, which may include control of a control arrangement comprising valves and/or flaps, which allow acoustic noise to propagate from the duct 200 into the resonators 112.

The resonance frequency of each resonator 112 may be based on position of the resonator relative to the duct 200. The resonators 112 may be arranged so that a resonator of a particular resonance frequency is provided at a position (or location) along the duct 200 to build up a variation (e.g., increase, decrease, and/or exponential variation) in resonance frequency along the duct 200.

The resonators 112 may be arranged to provide a variation in resonance frequency of each resonator 112 with position of the resonators relative to the duct 200. The variation may be an exponential variation of resonance frequency along the duct 200. As each resonator 112 controls a range of frequencies, the variation with position results in control of multiple frequencies of the acoustic noise along the duct 200.

The variation may be an increase or decrease in resonance frequency of each resonator 112 along the length of the duct 200. In this way, acoustic noise may be controlled.

In the examples illustrated and described herein, the resonator arrangement comprises Helmholtz resonators. Helmholtz resonators have a high transmission loss, but only operate to control acoustic noise in a narrow frequency band. By an arrangement of resonators 112 of differing resonance frequency, a wide band of acoustic noise frequencies can be controlled. Furthermore, such an arrangement can filter acoustic noise spectrally and spatially to reduce noise and interference in a wide frequency band. It will be appreciated by those skilled in the art that other forms of resonators may be employed in the resonator arrangement 110, for example quarter wavelength resonators. Helmholtz resonators and quarter wavelength resonators may be employed in combination in a resonator arrangement 110.

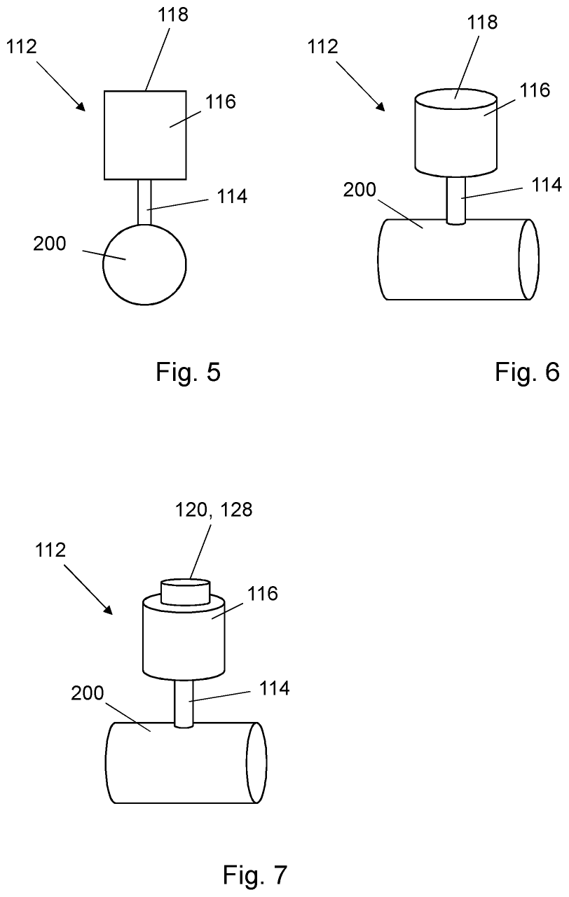

Referring to FIGS. 5 and 6, in the present example, the Helmholtz resonators comprise a neck 114 and a cavity 116. The neck 114 and cavity 116 are arranged to provide a resonance frequency to match a frequency of acoustic noise that it is desired to control. In this way, the resonators can be specifically configured to target certain frequencies of acoustic noise.

In the Helmholtz resonators, the neck 114 may extend into the cavity 116. In this way, the resonance frequency can be shifted down with increasing volume of the cavity 116.

The neck 114 may comprise one or more perforations. In this way, the resonance frequency may be shifted, and the transmission loss behaviour can be modified, thus improving noise attenuation performance of the Helmholtz resonator at low frequencies.

The Helmholtz resonator may comprise a flexible end plate 118. In this way, the frequency response characteristic of the resonator 112 may be modified. Thus, multiple distinct resonance frequencies may be provided, rather than a single resonance frequency. Therefore, acoustic transmission loss may be increased at each of the multiple resonance frequencies of the resonator 112.

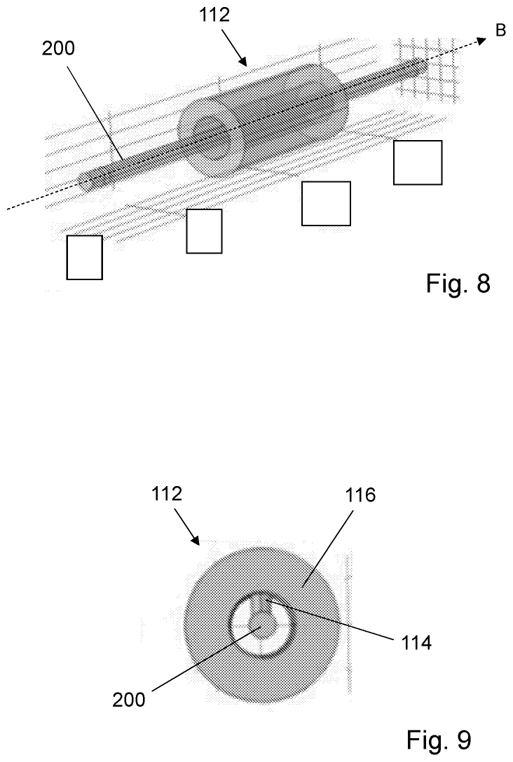

Referring to FIG. 7, the Helmholtz resonator 112 may be connected to a control assembly. The control assembly may be an electromagnetic shaker 120 and/or vibrating backplate 128. The electromagnetic shaker 120 and/or vibrating backplate 128 are operable to act on the Helmholtz resonator thereby to cause changes in the volume of the cavity 116. In this way, the resonance frequency of the resonators 112 can be tuned. As above, the tuning of the resonance frequency is based on (i.e., related to) the flow rate of fluid flow in the duct 200. In particular, a flow rate sensor provided in the duct 200, or elsewhere, may provide an input to the electromagnetic shaker 120 and/or vibrating backplate 128, and the input used to adjust or control operation of the electromagnetic shaker 120 and/or vibrating backplate 128 based on the flow rate.

In an example, the duct 200 forms part of a system-to-be-controlled. The system-to-be-controlled (e.g., acoustically controlled) may be a combustion system or a ventilation system. Such systems typically require fluidic ducts, and thus providing the present acoustic control system 100 is advantageous in controlling acoustic noise in an improved manner by considering fluid flow in the duct 200.

The fluid flow in the duct 200 may be a liquid flow. Liquid flow may generate high levels of acoustic noise. Thus, the present acoustic control system 100 is highly advantageous in reducing the effects of acoustic noise generated by the liquid flow. The liquid flow may generate undesirable noise or vibrations of the system-to-be-controlled.

The resonators arrangement 110 may be provided in a series arrangement or parallel arrangement. That is, the resonators 112 may be provided in series or in parallel. In a series arrangement of the resonators 112, the magnitude of transmission loss at the resonance frequency may be increased. In a parallel arrangement of the resonators 112, the magnitude of transmission loss may be logarithmically increased, as well as the bandwidth increased.

The acoustic control system 100 may comprise a platform to which the resonator arrangement 110 may be connected. The resonator arrangement 110 is configured based on the flow rate of the fluid flow in the duct 200. The platform may receive (e.g., by connection thereto) the configured resonator arrangement 110. The platform may be provided between the duct 200 and the resonator arrangement 110. The platform may comprise an arrangement, or series, of openings. The resonators 112 may be connected to the openings. Each opening may be provided with a valve or flap.

Referring to FIGS. 8 and 9, a portion of the duct 200 is shown comprising a concentric resonator 112. The resonator arrangement 110 described above may comprise one or more concentric resonators 112. The cavity of the concentric resonator 122 may be concentric with the duct 200 to which the resonator 112 is connected. The cavity 116 of the concentric resonator 112 may have a tubular form. An axial view of the concentric resonator along the axis B is shown in FIG. 8. The neck 114 in visible in this axial view.

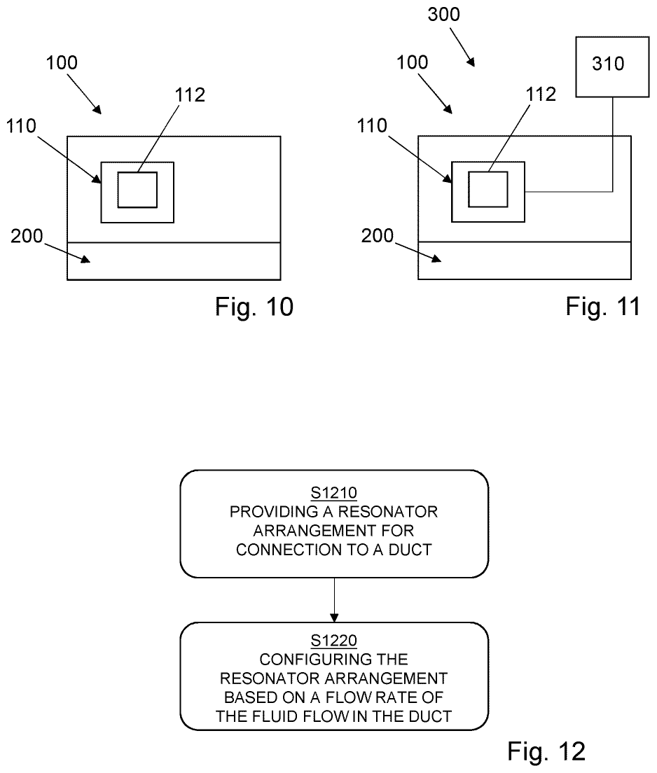

Referring to FIG. 10, the acoustic control system 100 is schematically illustrated. The acoustic control system 100 is in accordance with that described above. In particular, the active acoustic control system 100 is for controlling acoustic noise in a duct 200 arranged to receive fluid flow therein. The acoustic control system 100 comprises a resonator arrangement 110 for connection to the duct, the resonator arrangement 110 comprising a plurality of resonators 112, wherein the resonator arrangement 110 is configured based on a flow rate of the fluid flow in the duct 200.

Applicable to the acoustic control system 100 described herein, the resonator arrangement 110 may be configurable based on the flow rate of the fluid flow in the duct 200. That is, the resonator arrangement 110 may be adjusted or selectively constructed (i.e., repurposed) based on the flow rate.

Referring to FIG. 11, an active acoustic control system 300 is schematically illustrated. The active acoustic control system 300 comprises the acoustic control system 100 as described herein. That is, the active acoustic control system 300 may comprise any or all of the features of the acoustic control system 100, as described herein. The active acoustic control system 300 further comprises an active control assembly 310 arranged to control the resonator arrangement 110 based on the flow rate of the fluid flow in the duct 200.

The active control assembly 310 may arranged to control the resonator arrangement 110 based on the flow rate in one or more of the following ways:
selectively engage one or more of the resonators 112 of the resonator arrangement 110 with the duct 200. This may be achieved by valves or flaps which allow acoustic noise into the resonators 112.
adjust the position of the resonators 112 relative to the duct. This may be achieved by an actuator arrangement configured to adjust said position.
adjust or control the resonance frequencies of the resonators 112 of the resonator arrangement 110. This may be achieved by controlling an electromagnetic shaker and/or a vibrating back plate. Additionally, or alternatively, this may be achieved by providing resonators of controllable size by virtue of an adjustable cavity or neck.

Referring to FIG. 12, a method is schematically illustrated. The method is a method of controlling acoustic noise in a duct arranged to receive fluid flow therein. Step S1210 comprises providing a resonator arrangement for connection to the duct, the resonator arrangement comprising a plurality of resonators. Step 1220 comprises configuring the resonator arrangement based on a flow rate of the fluid flow in the duct.

1. An acoustic control system for controlling acoustic noise in a duct arranged to receive fluid flow therein, the system comprising:
a resonator arrangement for connection to the duct, the resonator arrangement comprising a plurality of resonators, wherein the resonator arrangement is configured based on a flow rate of the fluid flow in the duct.

2. The acoustic control system according to claim 1, wherein a resonance frequency of each resonator is based on the flow rate.

3. The acoustic control system according to claim 1, wherein a resonance frequency of each resonator is based on position of the resonator relative to the duct.

4. The acoustic control system according to claim 3, wherein the resonators are arranged to provide a variation in resonance frequency of each resonator with position of the resonators relative to the duct.

5. The acoustic control system according to claim 4, wherein the variation is an increase or decrease in resonance frequency of each resonator along the length of the duct.

6. The acoustic control system according to claim 1, wherein the resonator arrangement comprises Helmholtz resonators and/or quarter wavelength resonators.

7. The acoustic control system according to claim 6, wherein the Helmholtz resonators comprise a neck and a cavity, wherein the neck and cavity are arranged to provide a resonance frequency to match a frequency of acoustic noise that it is desired to control.

8. The acoustic control system according to claim 7, wherein the neck extends into the cavity.

9. The acoustic control system according to claim 7, wherein the neck comprises perforations.

10. The acoustic control system according claim 7, wherein the Helmholtz resonator comprises a flexible end plate.

11. The acoustic control system according to claim 7, wherein the Helmholtz resonator is connected to an electromagnetic shaker and/or vibrating backplate, to act on the Helmholtz resonator to cause changes in the volume of the cavity.

12. The acoustic control system according to claim 1, wherein the duct forms part of a combustion system or a ventilation system.

13. The acoustic control system according to claim 1, wherein the fluid flow in the duct is a liquid flow.

14. An active acoustic control system comprising:
the acoustic control system according to claim 1; and
an active control assembly arranged to control the resonator arrangement based on the flow rate of the fluid flow in the duct.

15. A method of controlling acoustic noise in a duct arranged to receive fluid flow therein, comprising:
providing a resonator arrangement for connection to the duct, the resonator arrangement comprising a plurality of resonators; and
configuring the resonator arrangement based on a flow rate of the fluid flow in the duct.

16. A system comprising:
a resonator arrangement for connection to a duct, the resonator arrangement comprising a plurality of resonators, wherein the resonator arrangement is configured based on a flow rate in the duct;
wherein a resonance frequency of each resonator is based on position of the resonator relative to the duct; and
wherein the resonators are arranged to provide a variation in resonance frequency of each resonator with position of the resonators relative to the duct.

17. The system according to claim 16, wherein a resonance frequency of each resonator is based on the flow rate, and the variation is an increase or decrease in resonance frequency of each resonator along the length of the duct.

18. The system according to claim 16, wherein the flow rate in the duct is a liquid flow rate.

19. The system according to claim 16, wherein the plurality of resonators includes:
a first resonator for connection to a duct and having a first resonance frequency, wherein the first resonance frequency is based on a flow rate of the duct and a position of the first resonator relative to the duct; and
a second resonator for connection to the duct and having a second resonance frequency different from the first resonance frequency, wherein the second resonance frequency is based on the flow rate of the duct and a position of the second resonator relative to the duct;
wherein the first and second resonators provide, when connected to the duct, a variation in resonance frequency along the duct.

20. The system according to claim 19, comprising an active control assembly arranged to control the first and second resonators based on the flow rate in the duct.
